(19) United States
(12) Patent Application Publication
(10) Pub. No.: US 2006/0168096 A1
(43) Pub. Date: Jul. 27, 2006

(54) Web servers

(76) Inventors: Ian John Hayward, Lapley (GB); Paul Simon Booker, West Midland (GB)

Correspondence Address: KOHN & ASSOCIATES PLLC, 30500 NORTHWESTERN HWY, STE 410, FARMINGTON HILLS, MI, 48334, US

(21) Appl. No.: 10/542,964

(22) PCT Filed: Jan. 21, 2004
(86) PCT No.: PCT/GB04/00172

§ 371 Date: Feb. 13, 2006

(30) Foreign Application Priority Data
Jan. 21, 2003 (GB) 0301343.0
Apr. 29, 2003 (GB) 0309785.4

(51) Int. Cl. G06F 15/16

(52) U.S. Cl. 709/217; 709/226

(57) ABSTRACT

A web server comprising a memory and an information processor, the memory including a stored web page viewable by a remote user, wherein the stored web page is alterable by the remote user in at least one of appearance and function.

### CROSS-REFERENCE TO RELATED APPLICATIONS

This patent application is a National Phase filing of PCT/GB04/000172, filed Jan. 21, 2004, which claims the benefit of priority of Great Britain Patent Application Serial No. 0301343.0, filed Jan. 21, 2003, and Great Britain Patent Application Serial No. 0309785.4, filed Apr. 29, 2003, all of which are incorporated herein by reference.

### TECHNICAL FIELD

This invention relates to systems and web pages for improving use of the Internet.

### BACKGROUND

It is known to use a web browser which displays a web page in its main window and which has a stored list of web links or internet short cuts sometimes called “favourites” and in this specification called “links”, which can be edited by a user. Consequently a user can store links for websites and pages, which the user uses regularly, can return to these sites and pages by selecting the stored links without needing to remember the correct url address. However these links are stored locally on the user computer (web client), which was used when the links were stored. Should the user use a different computer such as at work, whilst visiting others or in an internet cafe or library then these links are inaccessible.

It is also known to provide websites that harness so called “dynamic” html that alters the html of the site when a user fulfills a predetermined function such as clicking on or moving a cursor over a menu. However, the html is altered in a manner predetermined by the web designer and not by the user and consequently always alters in the same manner regardless of the needs of the user.

It is an object of the invention to provide improvements on such systems and in particular to help users who wish to use stored links on independent computers. It is also an object of the invention to provide formatted areas of a web page and/or browser that can be created and/or altered.

### SUMMARY OF THE INVENTION

According to a first aspect of the invention there is provided a web server comprising a memory and providing an interface for use by a remote user, preferably for navigating web pages, which interface is editable/alterable by a remote user such as in appearance and/or function.

Preferably the interface includes web links such as short cuts to web pages which can be used by a remote user to access web pages, wherein more preferably the links can be created, deleted and/or edited by a remote user.

Preferably the interface comprises formatted areas at least some of which can be altered in appearance by a remote user, more preferably the user may select the appearance of the area from a list of available appearances stored in the memory of the web server. Preferably still the list of appearances of formatted areas stored in the memory can be added to or otherwise edited remotely of the web server.

Preferably the interface comprises dynamic html such as in the form of drop down menus and more preferably the dynamic html can be edited remotely by a user and the edited dynamic html used by the remote user. Preferably still the dynamic html can be edited and used completely over the internet.

Preferably any activity which a user is enabled to perform by the web server can be done independently of the location and/or computer and/or local memory the user has when accessing the web server.

Preferably the web server can be used by multiple users, more preferably each user can be identified and the interface provided to them depending on that identification, preferably still whereby edits performed by one identified user are stored in the web server memory independently of a differently identified user and an interface corresponding to the edits stored for the respective identified user is provided to that user.

According to a second aspect of the invention there is provided a web server hosting a web page, the web page incorporating dynamic html, wherein the dynamic html can be edited by a user viewing the web page remotely.

According to another aspect of the invention there is provided a method of facilitating electronic marketing to individuals comprising the steps of: setting up an electronic address for each individual accessible via a web server, requiring the individual to enter security information such as a username and password in order to access their electronic address and allowing the electronic address to be accessible to its corresponding individual over the internet form multiple different computers, requesting and storing information about individuals, enabling third parties to select individuals based on the stored information, enabling third parties to send marketing material such as advertising to the electronic addresses of the selected individuals, requesting feedback from selected individuals and relaying feedback to third parties enabling them to make a decision as to whether to continue sending marketing material to that individual.

The invention and/or interface of the invention may comprise a website, web page, browser and/or browser plug-in.

Any feature described in this specification relating to the invention may be combined with any other feature described herein so as to define independent or dependent features of the invention.

### BRIEF DESCRIPTION OF THE DRAWINGS

An embodiment of the invention will now be described, by way of example only, with reference to the accompanying drawings in which:

FIG. 1 is an overview of the architecture of the system according to the invention,

FIG. 2A is a view of elements of a home page according to the invention,

FIG. 2B is a view of elements of a second embodiment of home page according to the invention,

FIG. 3 is a flow diagram of the process of the user accessing a web page by selecting a link,

FIG. 4A is a view of elements of the home page of FIG. 2A in a different configuration,

FIG. 4B is a view of elements of the home page of FIG. 2B in a different configuration,

FIG. 5 is a flow diagram of the process of a user logging in,

FIG. 6 is a view of a set up page for updating links,

FIG. 7 is a flow diagram of the process of a user modifying links in the menu,

FIG. 8 is a flow diagram of the process of uploading links from a PC,

FIG. 9 is a view of a web page for importing links,

FIG. 10 is a view of a urlist.txt file when importing links,

FIG. 11 is view of a web page displaying imported links,

FIG. 12 is a view of the set up web page of FIG. 6 with added links,

FIG. 13 is a close up view of the “move link” in FIG. 12.

FIG. 14 is a view of a set up page for moving links,

FIG. 15 is a view of a page that requests log in details from a client,

FIG. 16 is a view of a page allowing a client to create or modify skins,

FIG. 17 is a view of a page of the first tab from a menu for creating skins,

FIG. 18 is a view of the page of FIG. 17 in a second configuration,

FIG. 19 is a view of a page of the second tab from a menu for creating skins,

FIG. 20 is a view of a page of the third tab from a menu for creating skins,

FIG. 21 is a view of a page of the fourth tab from a menu for creating skins,

FIG. 22 is a view of a page of the fifth tab from a menu for creating skins which displays a preview of the skin,

FIG. 23 is a view of a page displaying submitted skins to administrators,

FIG. 24 is a view of a page of the first tab from a menu for a user to manage skins,

FIG. 25 is a view of a page of the second tab—from a menu for a user to manage skins allowing the user to purchase skins,

FIG. 26 is a view of a page of the third tab from a menu for a user to manage skins,

FIG. 27 is a view of a page of the fourth tab from a menu for a user to manage skins allowing a user to select a search engine, and

FIG. 28 is a view of a feedback page using which a user may send messages to the creator of a skin.

### DETAILED DESCRIPTION

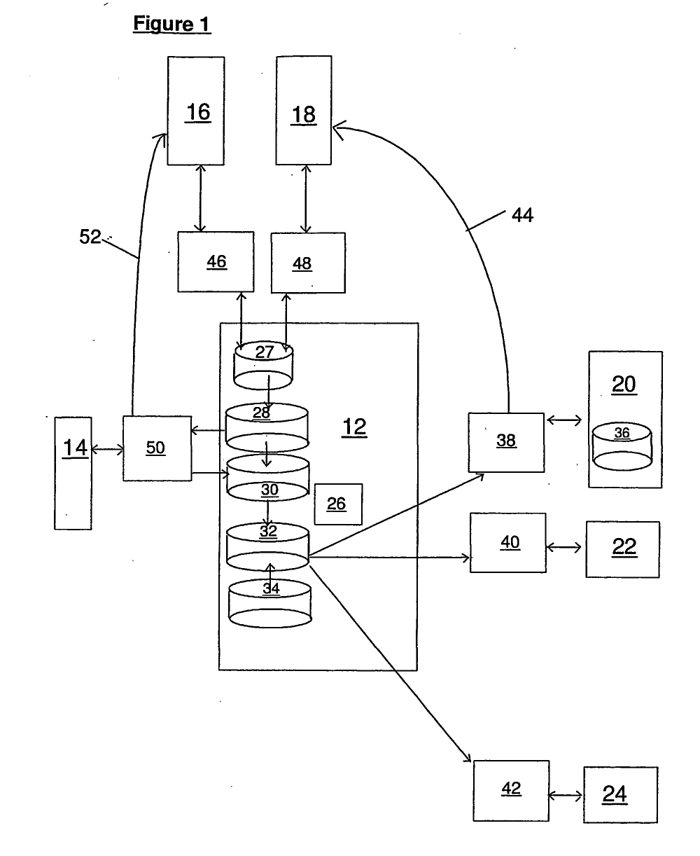

Referring to FIG. 1 there is shown a system 10 according to the invention comprising a web server 12, operator PC 14, client PCs (Personal computers) 16 and 18 and user PC's 20, 22 & 24.

The web server 12 comprises a processor 26 in communication with a memory including a client identification database 27, a pending skins database 28, a live skins database 30, a user identification database 32 and a user information database 34. Stored in the memory is a multitude of web pages 38, 40, 42, 46, 48 and 50 each corresponding to one or more of the databases 28, 30, 32 & 34, the web pages being transmitted in response to requests from remote PCs such as the operator PC 14, client PC's 16 & 18 or web user PC's 20, 22 & 24.

Each user PC 20, 22 & 24 includes a local PC memory 36. The local PC memory 36 has a web browser stored in it, the browser able to request web pages from the web server 12 and communicate with the web server 12 via these web pages.

Each user PC 20, 22 & 24 interfaces with the web server 12 via an individual web page or web pages 38, 40 & 42. The web pages 38, 40 & 42 corresponding to information stored in identification database 32 whereby each of the individual web page or pages 38, 40 & 42 being uniquely identified with information corresponding to a user U. The identification database 32 communicates with the user information database 34 thereby displaying information specific from the user information database to each identified user on their respective web page 38, 40 or 42.

There is also a communication channel 44 from the web server 12 to the client PC's 16 & 18 which is usable by a user PC 20 via a user web page 38 to communicate with the client PC 16 or 18. The communication channel 44 may take the form of a mail server allowing electronic messages such as emails to be sent to the client PC 18.

The client PCs 16 & 18 also comprise web browsers, which web browsers can be used to request client web pages 46 & 48 from the web server 12. The client PCs 16 and 18 are able to interface with the client identification database 27 via these web pages 46, 48.

The operator PC 14 also comprises a web browser, the web browser being useable to request and operate an operator web page or web pages 50 from the web server 12. The operator PC 14 is able to view information stored in the pending skins database 28 and is able to transmit information to the live skins database 30 the operator web page 50. There is also a operators communication channel 52 similar to the first communication channel 44 allowing electronic messages such as emails to be sent by the operator's PC via the web page 50 to a client PC 16 or 18.

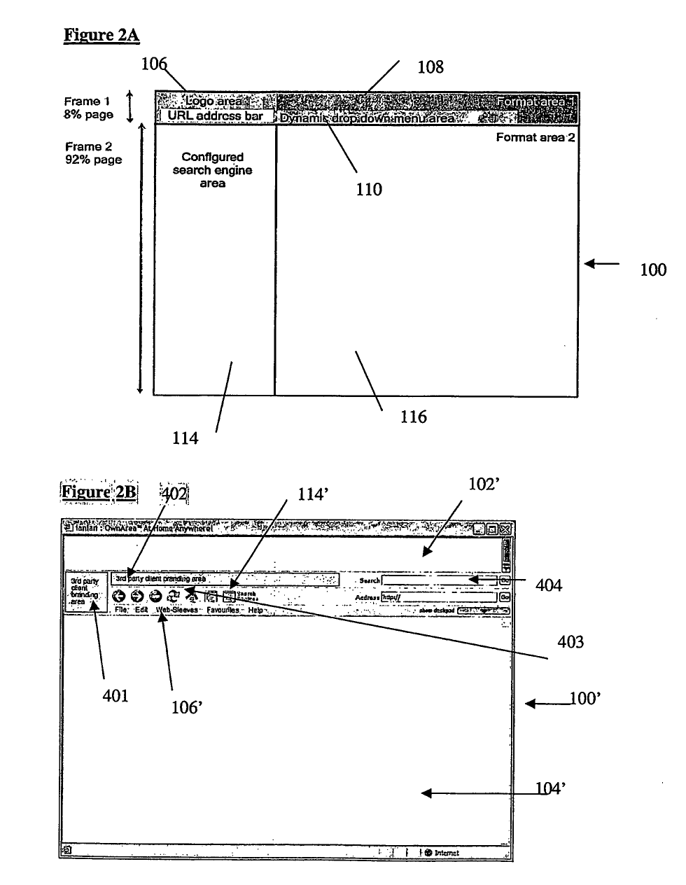

In FIG. 2A is shown elements of a typical home page 100 presented to a user when logged in and forms one of the user web pages 38. The home page 100 comprises two frames, first frame 102 and second frame 104. In the particular embodiment shown in FIG. 2A, the first frame 102 occupies 8% of the page hi-lighted and contains tabulated html created by PHP coding. The first frame 102 occupies a parallel sided horizontal slice of the web page 100. In alternative embodiments first frame 102 may also comprise a vertical section running down the left or right hand side of the web page 100 and could typically occupy any amount of the page from 5% to around 25% of the overall page 100.

First frame 102 comprises a left hand portion 106 and a right hand portion 108. The left hand portion 106 may contain logos, trade marks and other information relating to the company running the web server 12 and also a text box with a submit button. The right hand portion 108, in this example occupying 500 of the total 700 pixels across the width of the page 100, contains a menu of dynamic html which in the configuration in FIG. 2A is displayed to the user U as a series of menu headings. The right hand portion 108 also comprises a first formatted area 112, the appearance of which can be selected by the user U as described later in the specification.

The second frame 104 in FIG. 2A occupies 92% of the page 100 but could typically comprise from around 95% to about 75% of the web page area. The second frame 104 also contains tabulated html created by an embedded scripting language such as by using PHP coding. The second frame 104 comprises a left hand portion 114 and a right hand portion 116. The left hand portion 114 is the same width as left hand portion 106 and contains user configurable links to popular search engine web sites and links to various customised customized formatted areas that the user U is able to choose.

The right hand portion of the second frame 104 comprises a second formatted area 118.

In FIG. 2B is shown elements of a configuration of an alternative home page 100′ presented to a user when logged in and forms one of the user web pages 38. Similar or identical elements to those in homepage 100 are given the same label but proceeded with a ′. Where applicable the description of later figures applies equally to homepage 100′ and its corresponding elements as well as homepage 100. The homepage 100′ comprises three main sections which each can comprise more than one frame. In the particular embodiment shown in FIG. 2B, the first section 102′ occupies the top area of the page which can contain third party client web content that can be delivered into the user U's browser environment. This content is referred to as “above the bar” content the appearance of which can be selected by the user U in the same manner as first frame 100 as described later in the specification.

The second section 110′ contains a menu of dynamic html which in the configuration in FIG. 2B is displayed to the user U as a series of menu headings.

The third section 104′ in FIG. 2B occupies the main area of the page 100′. This third area 104′ also contains third party client web content that is delivered into the users browser environment and this content is referred to as “below the bar” content the appearance of which can be selected by the user U in the same manner as second frame 104 as described later in the specification. The “below the bar” content can be contextually linked in same third party content ownership to the content that is displayed “above the bar”.

In between the first section 102′ and the second section 110 additional frames can be located. In the example in FIG. 2B there are two client branding areas 401 and 402, a browser function area 403 which incorporates typical browser functions, a portion 114′ with links to popular search engine web sites, and a search input 404.

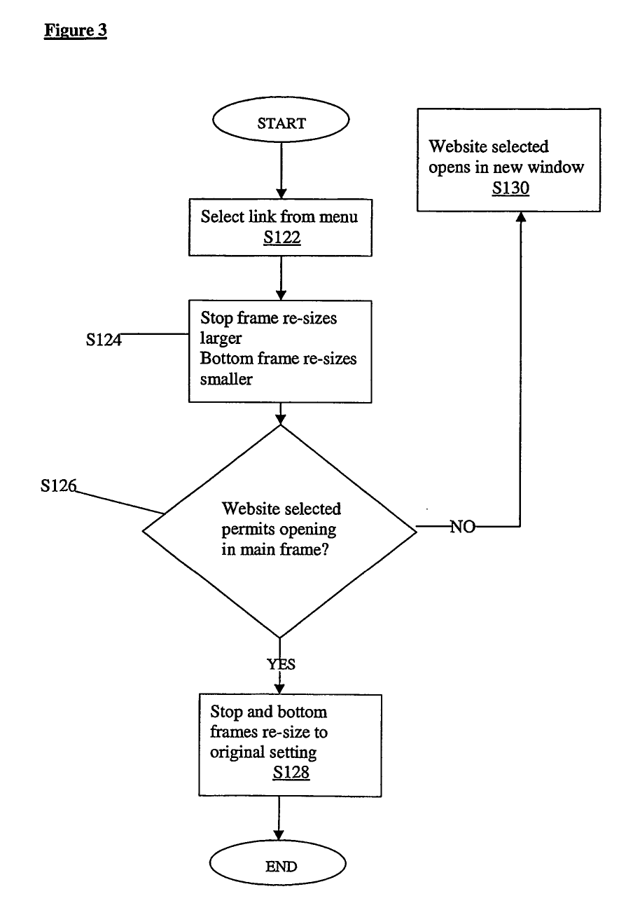

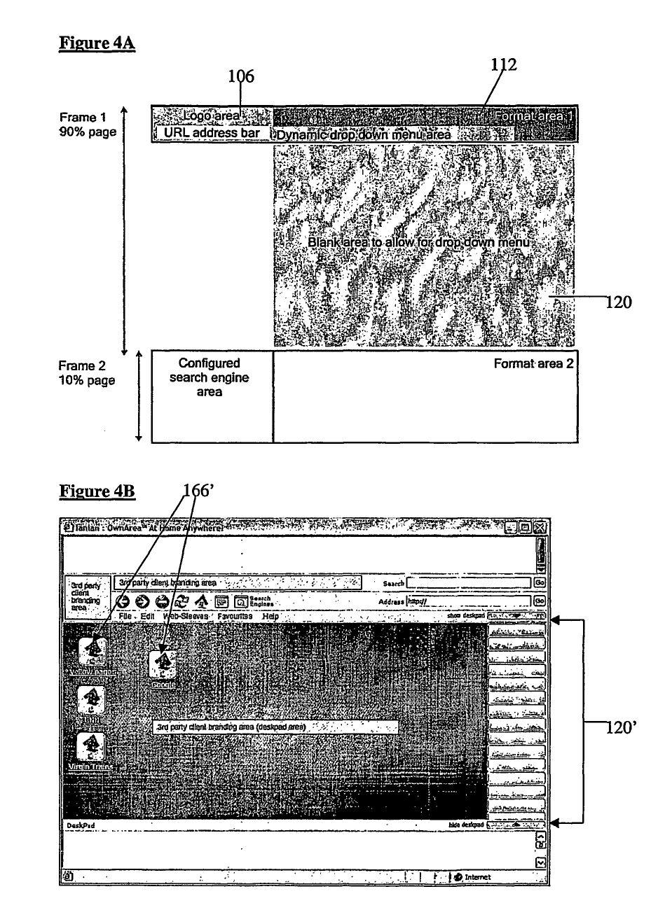

Referring to FIG. 3 there is shown the process of selecting web site by way of a short cut stored as links within the dynamic menu 110. At step S122 the user U selects the dynamic menu 110, commonly by clicking with a mouse. Consequently the first and second frames 102 and 104 re-size as shown in FIG. 4.

In FIG. 4A it can be seen that the first frame 102 is enlarged significantly to now occupy 90% of the web page 100 and second frame 104 is correspondingly reduced in size to about 10% of the web page 100.

The left hand portion 106 remains the same size as does the electable formatted area 112. The area occupied by the dynamics menu 110 however has increased significantly. The dynamic html of which the menu 110 is comprised is configured such that by selection of the menu 110 the small area merely showing menu headings as displayed in FIG. 1 is replaced by the full drop down menu 120 shown in FIG. 3. The drop down menu 120 contains links which are in effect short cuts to other web pages.

In FIG. 4B it can be seen that when the steps are applied to homepage 100′, the second section 110′ is enlarged significantly and occupies more of the visible area. This section 110′ now shows an expanded area that permits the drop down menus 120′ to appear to the user. The third area frame 104′ is correspondingly reduced in size.

In the drop down menu 120′ “shortcut” graphic icons 166′ form links to other web pages. The user U may configure and “drag” these icons around the drop down menu and to place these icons 166′ wherever they wish. System 10 remembers where these icons are placed, recording the coordinates by activating a script in a hidden 0 pixel height frame and storing this information in the user information database 32. Consequently icons 166′ can be reproduced in the exact position they were left at for the user U when they next log in regardless of if the user access the browser environment from a different computer.

At the next step S125 the user U selects a web site from those listed in the drop down menu 120 area and provided at step 126 that the web site selected permits opening within a frame then the process continues to step S128. Certain web sites however do not permit users to view them in frames and in this case at step S130 a new window is opened with the relevant web site selected. In another embodiment it is also possible for the user U when storing a web site link in the drop down menu 120 to specify that the web page when selected is to open in a new window

At step S128 the first and second frames 102 and 104 return to their original size as depicted in FIG. 2A with the drop down menu 120 been removed from the visible area. The second formatted area 118 will now contain the web page to which the link which is selected corresponds. Should the dynamic menu 110 be selected again then the frames 102 and 104 will again re-size to the sizes shown in FIG. 3. However, the web page displayed in the first formatted area 112 in frame 104 will continue to be shown.

Whilst the selected web page is displayed in the second format area 118 to a user U (or in a new window) the web page displayed is not known to the web server 12. This is because of known and inherent security features within most current browsers that do not allow any java script or other functionality to run within a foreign frame from another frame. So that whilst the web page 100 of the invention resides in the first frame 102 the web server 12 does not query the web address that is currently on display in the second frame 104.

When using homepage 100′ the user U may enter a search text directly in the search input area 404 this will result in the search result being show in area 104′, based upon the search engine of the users choice that is specified as their default chosen farourite engine in their set up details.

The user may also select the search engines button 114′ which opens up a separate pop up window, that displays a list of the users chosen search engines. This window offers search boxes for each search engine listed, and when filled in will show the result loaded into area 104′ and will leave the separate window open to the user, therefore a user may compare search results between different search engines easily.

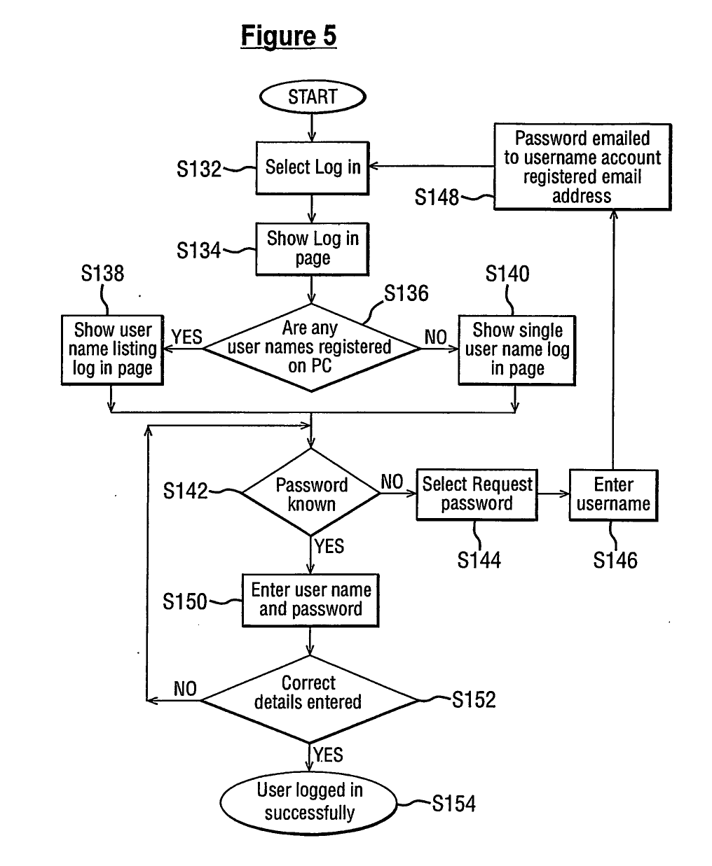

In FIG. 5 is shown the process of a user U logging to the system 10. When the user logs in at step S132 he or she is shown the login page, which may be in the form of a splash page, at step S134. At step S136 the process determines whether any user names are registered in the local PC memory 36, if there are the process proceeds to step S138 and if there are not the processor proceeds to step S140.

At step S138 a list of stored user names may be displayed to the user U on a web page 38 depending on the local settings and once the relevant user name UN is selected by the user U the process continues to step S142. At step S140 a user name is requested at a user name login page forming part of the user web pages 38. Once the user name is entered the process proceeds to step S142.

At step S142 the processor 26 determines whether a password has previously been entered for the entered user name by searching the user identification database 32 and if a password has not been previously entered the system proceeds to step S144 and if one has previously been entered then the process continues to step S150.

At step S144 the user U enters a password along with a user name at step S146. The user U may also be requested or required to enter additional user name account information such as their date of birth and/or a contactable email address Next at step S148 this password and user name account information is transmitted from the web server to the stored email address of the user name account. The user U must then re-login at step S132 and enter the received information

At step S150 the user U enters their password and then the processor 26 at step 152 determines whether these details correctly correspond to those stored in the user identification database 32. If they do not correspond the user is returned to step S142 and if they do correspond the user is successfully logged in at step S154.

In an alternative embodiment the user U may bypass the login page by typing their username and/or password as part of the url address when accessing the invention via their browser or computer desktop shortcut.

For security reasons it is possible for the system 10 to be configured such that only one user U can be logged in on any one given user name at one time. Consequently whilst the user U is logged under their user name it is not possible to login with a different browser under the same user name, whether on the same PC or on a different PC. This is achieved by using a database flag indicating that a users user's user name is to be locked whilst being used. This feature stops the possibility of one person creating data in order to publish for viewing as a group rather than individuals at the same time by a multi access login.

In order for the user name account to be unlocked the user must first exit or close the web site 38 in which they are logged in at by either selecting log out or close links, from within the first frame 102. If a user was unable to exit the site in this correct manner an unlock code must be entered via an on line request. An unlock code can be requested by the user to an email address on presentation of their user password. This unlock code can then be used to unlock their account. Preferably a new unlock code is needed each time this locking occurs.

Once logged in for the first time, the user is given an unique user identification number. The unique user identification number is stored in the user identification database 32 along with the user name and password. This unique user identification number is then tagged to the particular identified user including any personal details stored in the user information database 34, such as gender, birth date and age, ad reference number of the user's browser.

Other web servers can communicate with web server 14 in order to access the relevant part of the user identification database 32 to extract the unique user identification number. The number can then be used but the other web servers in the following way to track use of web sites hosted by those web servers. Whenever a user U accesses the relevant external web site through web page 38 of this invention, either by using a link or via typing into the URL address bar 26, the web server operating that external web site can be notified of the unique user number of the logged in user U.

The external web server can do this by placing some code script within it's webpage to obtain the “frame name” number that is allocated to frame 104 that the website page is being loaded into.

This action results in the website of the external web server obtaining a number that is unique to the combination of the specific User U's homepage 100 that has loaded their page and the server log in session number that is allocated to the User's browser.

The external web server may then choose to send this number via a live request to web server 14 that firstly validates an account number and password of the external web server using information in the client identification database 27. Upon successful validation of the account server 14 then queries the user information database 34 to establish the user details that are allocated to the unique number that has been sent via the external webserver request.

Web server 14 then sends a live posting back to the external web server that made the request and provides it with details pertaining to the User U that has loaded it's webpage. The detail of the data can be legally anonymous but detailed enough to uniquely identify the user profile and ref number.

An example of how to embed the unique identification reference number is given below with AUI used to represent the unique identification number, the websites 38, 40, 412, 100, 100′ having the address www.system.info.

| | |
|---|---|
| <script | language=″javascript″> |
| <!-- | |

| | |
|---|---|
| function | AUIQuery( ){ |

logID = window.name; // this gives site a text string denoted as “AUI(n)”
if(logID.slice(0,3) != ′AUI′) return false; // strips put text string to establish if
unique number is first three characters if not then site visitor is not a registered

| | | | | |
|---|---|---|---|---|
| user | U | of | system | 10. |

logID = logID.slice(3) ; // assigns the remaining numerical part of the frame

| | | | | | |
|---|---|---|---|---|---|
| text | string | to | the | variable | logID |

oawID = 1000; // this is the websites client account number will be more likely

to be generated by it's own database
url=”http://www.system.info/oa_aui_query.php?oaacc=45881773&oausr=w3ilnus
ername&oapwd=w3ilnpassword&oalog=″+logID+″&oasuc=http://www.w3iln.com/
success.php&oaerr=http://www.w3iln.com/failure.php&oawid=″+oawID ; // see

| variable | | list |
|---|---|---|
| | window.open(url) | ; |

| | |
|---|---|
| return | true; |

}
-->
</script>
When the external Webserver loads into system 10, the website can query the
log id. The system 10 then gives them the code and variable to use, as part of
their technical information when creating an account.
The website will then have to call the above page with the following variables
attached to the system 10 url
oaacc = the website account number
oausr = the website account username
oapwd = the external website account password
oalog = the system user log id from the users frameset
oaweb = the full url (SSL) plus the filename that the external website want the
user ID number returned to.
oaerr = the full URL plus filename (SSL) of the page to return to if the systme 10
does not successfully validate their account number oaacc & password oapwd
oawid = a unique number that the external website can generate to identify their
users site session.
oaaui = the system user's U ID number
oaref = a unique transaction number that is generate for this query instance
oacrd = number of website account credits left for identification queries
the URL post that the client website like Yahoo would do therefore would be
(SSL)
https://www.system.com/aui/system_aui_query.php?oaacc=theaccountnumber
&oausr=theusername&oapwd=thepassword&oalog=theuserlogID&oaweb=htt
ps://www.websitename.com/sucessfilename.ext&oaerr=https://www.websit
ename.com/errorfilename.ext&oawid=number
When the system 10 receives this information on page system_aui_query.php it
validates the external website 's oaacc + oapwd against the oaacc account
details on server 14.
If there is a successful validation the username/password system 10 posts url
tags to the external website success page as follows
https://www/websitename.com/sucessfilename.ext?oawid=number&oalog=userl
ogid?oaaui=userID&oaref=number &oacrd=number
oacrd = number of credits left after deducting one at the point of making this AUI
query
If it is not successfully validated the username/password we post url tags to the
website's error page as follows
https://www.websitename.com/errorfilename.ext?oawid=alphanumeric?oalog=us
erlogid?oaref=number?oacrd=number
+ the system 10 then flags the oaref record as an error transaction and not
deduct a credit from the oaacc account credits

Conventionally, web sites attempt to monitor user traffic, and customise customize settings based on “cookies”. Cookies are small amounts of data that are saved into the user's PC and which are located whenever a user of the PC returns to that site. When a cookie is detected it allows the web server to firstly configure the page to personal preferences of the user who downloaded the cookie and secondly, to measure how many and which are on its site and when. However, cookies do not distinguish between individuals but merely notify the web server of the computer being used. Most companies and web site providers are interested in users and not in computers. In particular where there are several people in a household a cookie would merely notify the household and not which person is using the computer. In the case of people who frequently use different computers such as at work, at home, at an internet café etc., then this user will have multiple different cookies which the relevant web server point will perceive as different users. A user using a different PC for the first time will be unable to benefit from any customistion customization of the website that cookie detection might bring even if they have used the site numerous times before.

Because the cookie is stored on the user's PC it can also be deleted by the user, thus removing any information related to the PC which the web site has stored. Beneficially by using the unique user identification number accessed from database 32, web servers are able to configure their hosted web sites to a specific person (that person having had the password and user name in order to log into system 10) and can accurately record frequency of use, amount of usage and numbers of users using their site via system 10.

In order to protect the user's identity and to comply with relevant Data Protection Acts laws and regulations in various countries, a user U of the present invention is preferably able to specify which information it is happy to be given to third parties, such as age, gender etc. These preferences of the user can then be stored in the user information database 34 tagged to the identification number within the identification database 32. Consequently, when a third party web server attempts to locate the user identification number from database 32, it can also be given information such as gender and age corresponding to that user U from the user information database 34, but only such information that has been permitted by the user will be sent. If such information is sent then external web servers cannot only use this information for statistical purposes but can also configure their site based upon the gender or age or other personal information relating to that particular user whenever they access their web site from system 10.

Dynamic menu 110 is generated using an embedded scripting language, and preferably a server-sided scripting language such as PHP, to access a relational database management system preferably relying on SQL such as MySQL to then construct a the menu 110/120 using java script and dynamic html formatting. The drop down menu 120 is dynamically created each and every time that a page is refreshed by moving the data from the database and creating the menu structure according to data specific to the user stored in the user information database 34.

The drop down menu 120 area may also contain search engine links under the a heading of Main with these search engine links also being based upon the users configured choices stored in the user information database 34.

The dynamic menu 110 in the configuration shown in FIG. 2A may consist of two major headings one called “Main” that contains the users preferred search engines and another called “skins” which is used to change the first formatted area 112 as described below. The dynamic menu 110 also has further menu headings typically four which may be dynamically named along with further optional sub-directories which have the facility to be dynamically re-named.

In a different embodiment there is also facility for displaying the directory structure and stored links down the left hand side of the screen in a textural format. In this format there is no restriction on the number of main menu headings but it is typically restricted to four on the drop down menu. This side menu can be accessed for example using active X controls with java script PHP and a suitable relational database management system such as MySQL.

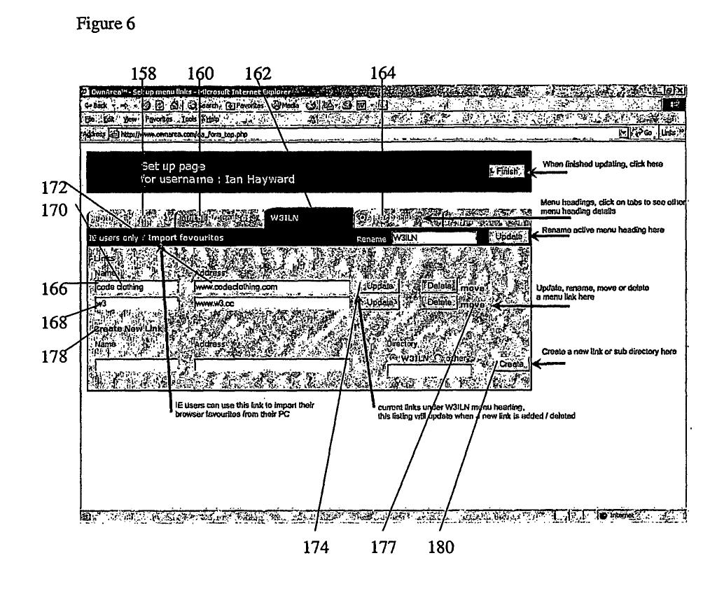

Within the dynamic menu 110 structure the user may create as many website names as they wish, each physical address having a linked name for display purposes with the menu 110. The menu links may be created and altered via a set up pages 157 accessed by the main menu as displayed in FIG. 6.

In FIG. 6 it can be seen that the set up pages 157 comprise four tabs 158, 160, 162 & 164 corresponding to the headings that are displayed as the dynamic menu 110. In FIG. 6 tab 162 has been selected and it can be seen from the page with the first tab 162 selected that the drop down menu 120 corresponding to the heading of the tab 162 presently contains two links 166 and 168. Each of the links 166 has a name 170 which will be displayed to the user in the drop down menu 120 and the correct URL address 172 which will be used by the system 10 to link to that page. It is possible to either up date or delete these links 166 and 168 using buttons 174 and 176.

Also provided at the create new link section 178 is the capacity to create a new link simply by entering a relevant name 170 and URL 172 and pressing the create button 180.

Web pages displayed by selection of tabs 158,160 or 164 are in effect identical to the page for tab 162 except that they may have a different selection and number of links. By using the headed named tabs a user U is able to effectively group relevant links together in a way preferred by themselves.

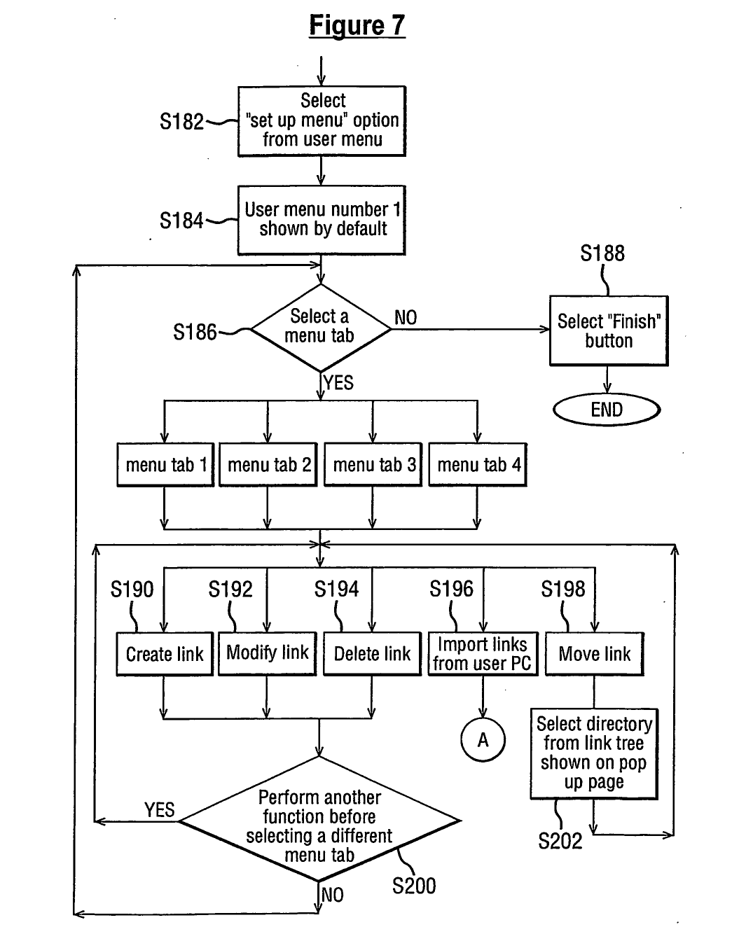

The process of adding, deleting, updating or moving links is shown in FIG. 7. At step S182 the user selects the set up option from the user menu 110 and a set up page 157 is displayed which by default will have the first tab 158 selected at step S184. However, at step S186 the user is able to select any of the other tabs 160, 162 or 164. The user U may also press the finish button 181 to terminate the process at step 188.

Once the correct tab has been selected the user U has the option of creating a new link at step S190, modifying an existing link at step S192, deleting the existing link at step S194, importing links from their memory of their PC at step S196 and moving an existing link at step S198.

At step S190 the user U enters the relevant name 170 and url 172 in the create new links section 178. url may be entered as domain.tld www.domain.tld or http://www.domain.tld and all three will be displayed as http://www.domain.tld however if http://domain.tld is entered it is determined that the www is not required and the url is stored as typed.

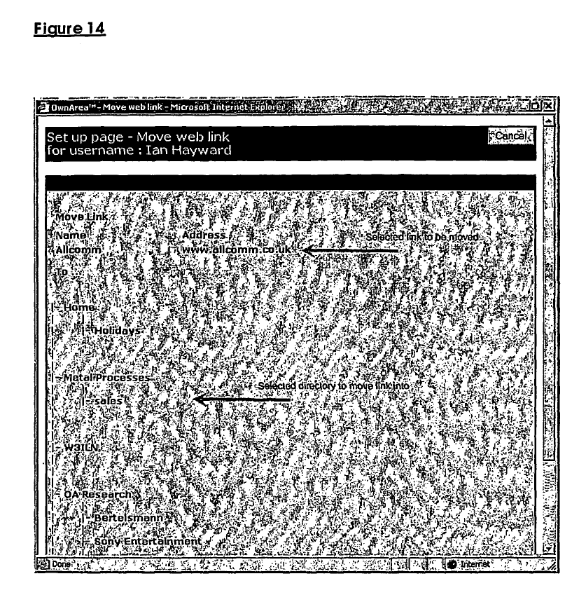

At step S192 an existing link is modified simply by changing the name 170 or 172 and pressing the update 174 button whilst at step S194 an existing link can be deleted simply by pressing the delete button 176. At step S198 an existing link to a different heading can be moved by pressing the move button 177 and entering which tab the user wishes the link to be moved to using page 179 shown in FIG. 14.

The facility to import links from the user's PC at step S196 depends on whether this is relatively supported by the user's browser. Such facility is currently supported by internet explorer and can be selected by pressing button 179. This facility uploads those favoured stored in the users own browsers memory to the web browser and incorporates these links within the dynamic menu 110.

Once steps S190, S192 and S194 are completed the user is free to either add, modify, delete, import or move another link from this tab at S200 or to return to step S186. Once step S198 is completed the user must enter the relevant directory by a pop up screen that appears at step S202 before they return to step S165.

Once the selections have finished at step S18, the changes made by the user U are implemented by altering the relevant information stored in the user information database 34 (MySQL). Consequently the dynamic menu 110 created by the scripting language (such as PHP) will access altered information and display altered dynamic html. For example if the user U has added a link then the stored name of this new link will be displayed in the drop down menu 120 when the relevant heading is selected.

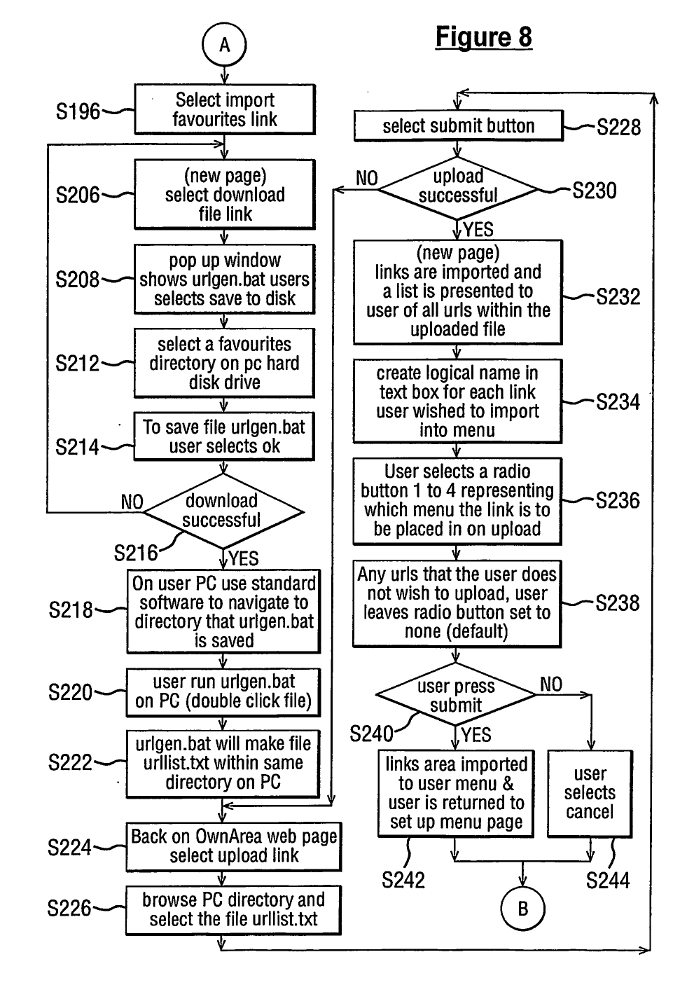

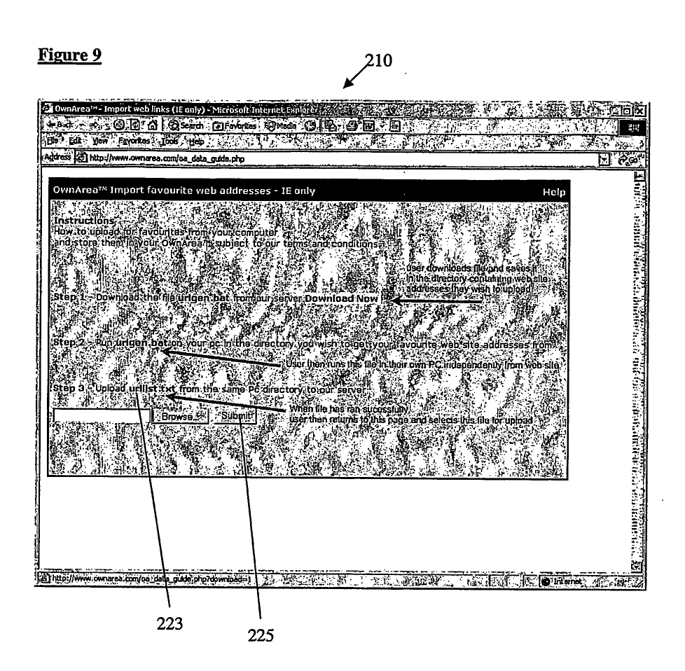

The process of importing links from the user PC memory 36 is shown in more detail in FIG. 8. At step S196 the user selects the import favoured link and then at step S206 a new page is displayed. At step S208 a pop up window 210 as shown in FIG. 9 is then displayed to the user from which the file urlgen.bat must be downloaded.

The user U selects a favourites directory on their PC memory 36 such as a hard disc drive at step S212 into which they save the file urlgen.bat At step 214 the user then selects OK if he/she wishes to continue. At step S216 the process then determines if the download has been successful, if it has not been the process turns to step S206 and if it has then the process continues to step S218.

Next the user must access the directory in which the urlgen.bat file is saved and run this file (such as by double clinking) at step S220. When activated the urlgen.bat file will create a new file urllist.txt within the same directory on the PC 20, 22 or 24.

At step S224 the user then selects the upload link 223 on page 210 and selects the file URLlist.txt at step 226 by browsing their PC directory. The submit button 225 is then selected at step S228 and the urllist.txt file is uploaded to the web server 12. At step S230 the processor 26 determines whether the file has been successfully uploaded to the user information database 3, and if it has not been the process returns to step S224 and if it has been the process continues

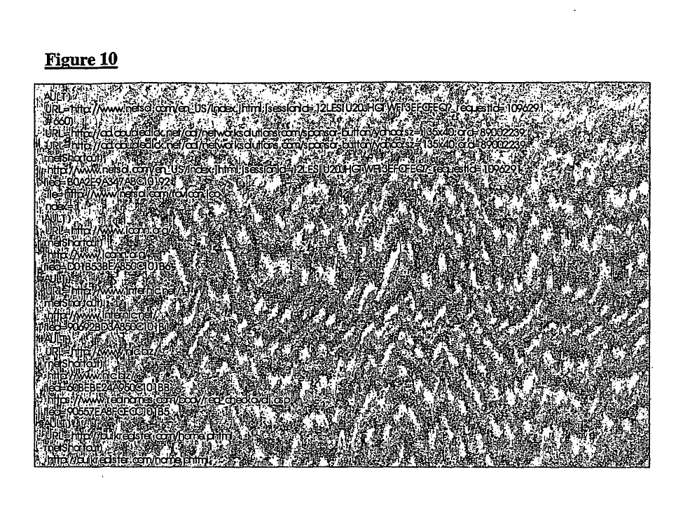

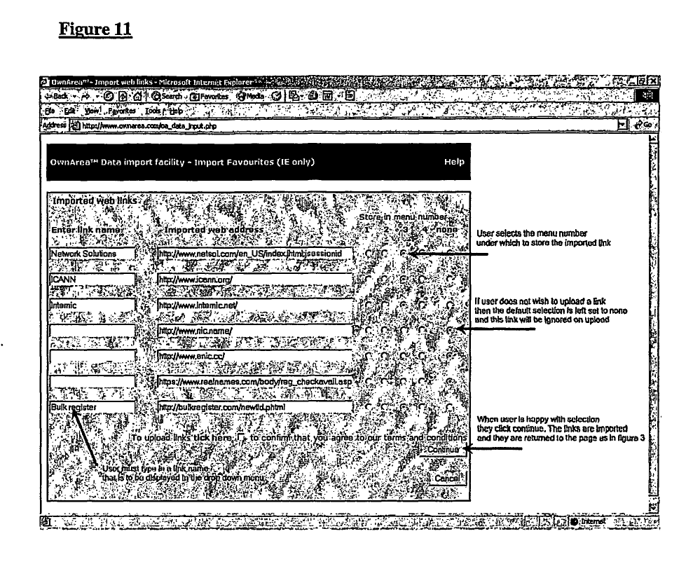

At step S232 the user U is presented with a list of the urls of each of the links they have requested as depicted in FIG. 10.

Next at step S234 the user U is displayed the web page 227 and creates logical names in the text box 229 for each link that the user wishes to import into the dynamic menu 110. Then at step S236 the user and selects which of the tabs 158-164 the user U wishes the relevant link to be displayed in by clicking on the relevant circle in the “store menu number” section 231.

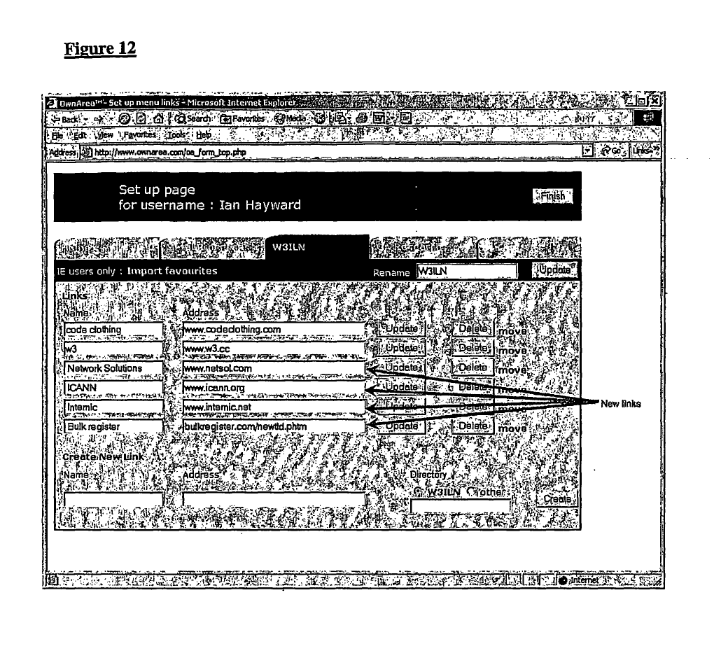

At step S238 the user U may also decide not to upload one or more links into the dynamic menu 110 by selecting a “none” circle 233. The user then presses the submit 225 button at step S240 and at step S242 the links area are imported into the dynamic menu 110 and the user is returned to the set up page 157 which now displays the imported links alongside the existing links as shown in FIG. 12. Alternatively at step S224 the user may select cancel from which no links are imported into the dynamic menu 110.

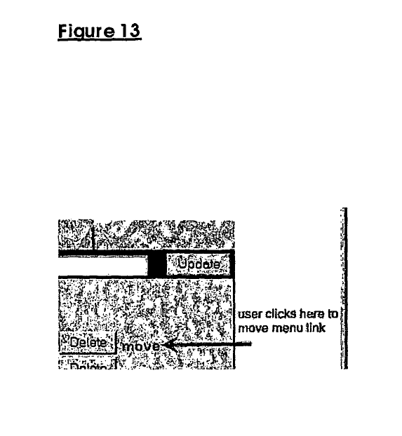

Imported links are not fixed under the tab they were imported to and can be moved in an identical manner to existing links by selecting the move button 177 shown close up in FIG. 13.

A client using a client PC 16 or 18 may create a background intended to form the first formatted area 112 herein referred to as a “skin”. In order to submit a skin for use by user U the client must step up an account with the administrators of the web server 12 and preferably agree to abide by its terms and conditions.

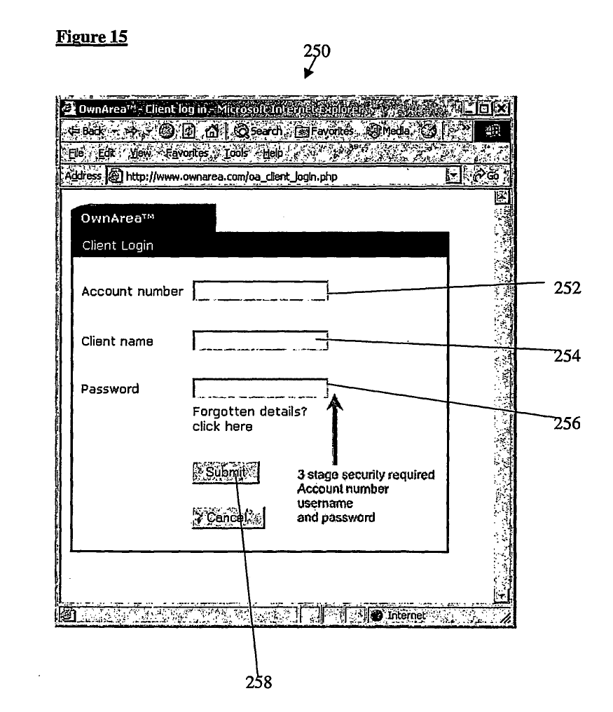

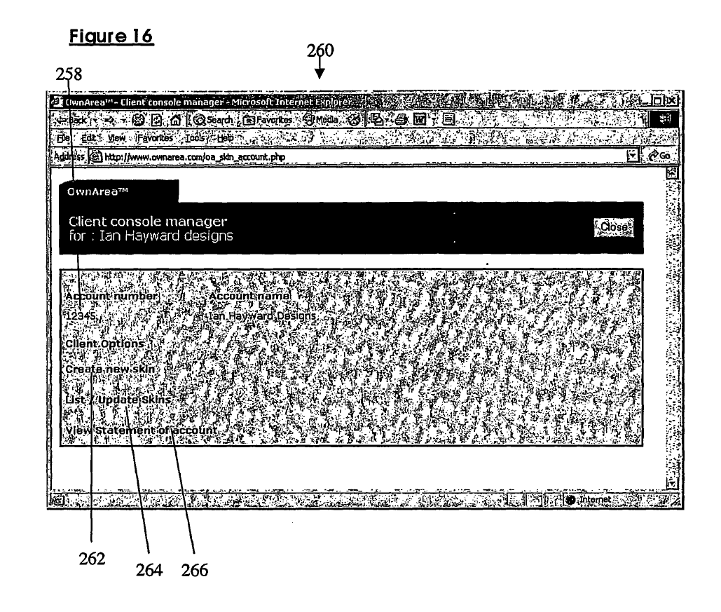

In FIG. 15 is shown the access page 250 forming part of the client web pages 46 and 48 for the client to log in to the system. This page 250 requests the client C to enter an account number, client name and password at 252, 254 and 256 respectively and to submit these by pressing the submit button 258. If these details are correct and correspond correctly to the corresponding information stored in the client identification database 27 the client will be shown the web page 260 displayed in FIG. 16. In an alternative embodiment the client has sub accounts of the client account and the skins reside within these sub accounts.

On Page 260 the client C is presented with three options, the create new Skin option 262, the list/update skin option 264 and the view statement of account option 266.

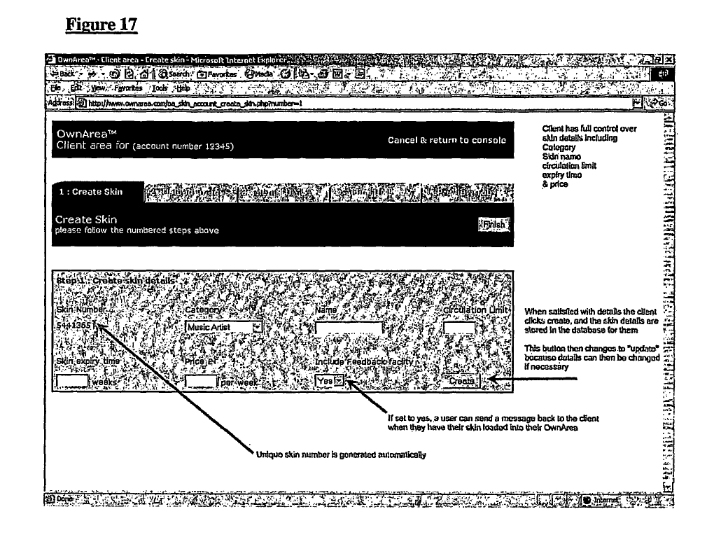

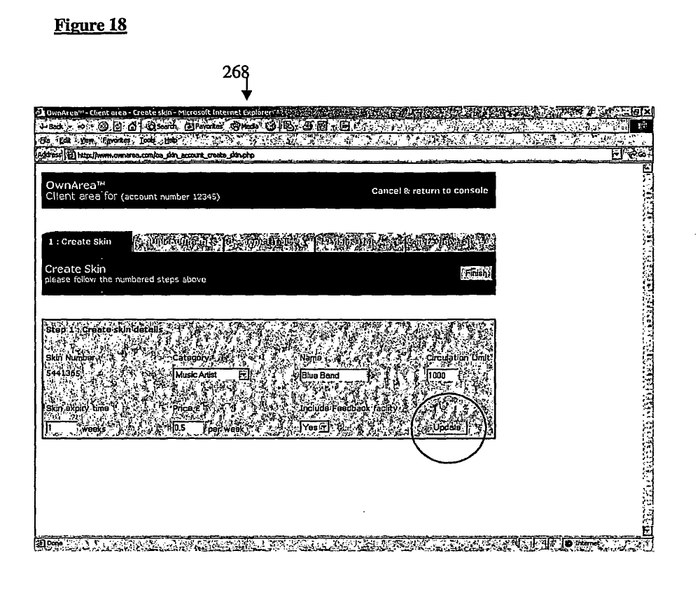

If the create new skin option 262 is selected the client is presented with a client page 268 comprising five tabs 270, 272, 274, 276 and 278 which is displayed in FIG. 17 with the first tab, the create skin tab 270 selected. With this tab 270 selected the client is able to choose a category to select a name and a circulation limit and skin expiry time and may be a price per week for their created Skin. In an alternative embodiment the client may also specify that the skin is to be location specific so that if the country of residence of a user U, which can be provided by the user U on registration or determined from the user's IP address, is not a country specified by the client then the user U will not be able to access that skin. A client may also specify that the skin is gender or age specific and similarly only those users with the relevant specified date of birth or gender registered will be able to access those skins. Further a client may specify that skins are to accessible only to a specific number or small group of users, or even specify which users it is to be accessible to based on their unique user identification number. This is particularly beneficial where the operator of system 10 charges for services or allowing client to give access to their skins.

The client is then able to target the specific users U based upon habits they have noticed by using the unique user identification number of that user browsing their own sites. Thereby the client can market and advertise to users in a manner more analogous to conventional marketing in which specific users and demographic groups of users can be directly targeted.

The client C can specify if the skin is to be classified as a salable skin or a direct-marketing (distributed) skin. A salable skin require the user U to pay a fee to install the skin whereby a direct-marketing distributed skin will be free to the end user and incur a delivery charge for the client.

If the client specifies a direct-marketed skin then they will have to pay the necessary fee and they may pre select the age, gender, and other specific stored demographic data in the user information database 34 on which to base the campaign. They can purchase the required number of user deliveries that their profiling options specifies and the skins will be delivered to the users accounts accordingly.

It is also possible for web page 38 to alert user U than user when a new skin is accessible through relevant information being displayed on the page 38. The e-mail address can also be stored in database 34 and if permitted by the user can be relayed to client C enabling the client to alert the user U to the availability of new skins by e-mail. Alternatively any other suitable messaging means could be used.

A created Skin is also automatically allocated a unique skin number 280 from which it can later be identified. Page 268 also provides the option of allowing critical feedback so that a user U can send a message back to the client C commenting on their Skin if they have loaded it into their first formatted area 112.

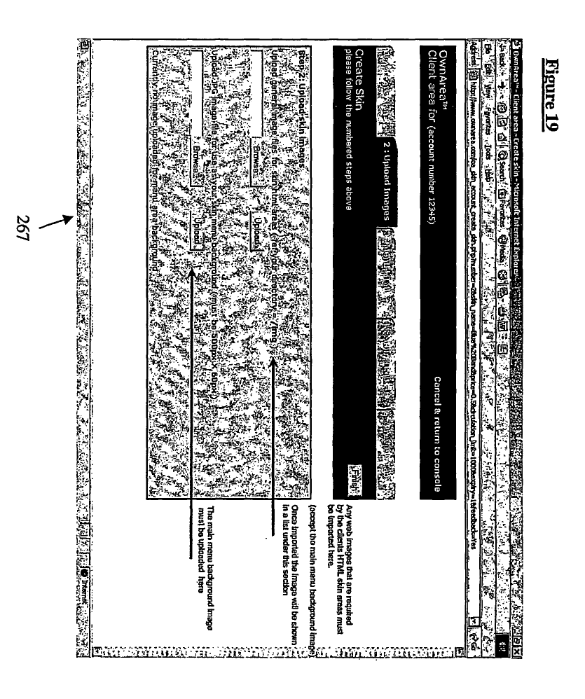

Page 268 is shown in FIG. 19 with the second tab, the upload images tab 272 selected. With the second tab selected the user is able to up load stored images as the new skin. Each Skin comprises three files, a background file designed to fit the second formatted area 118 when no web site is selected or if the selected web site is displayed in a separate window, a html file to use for the first formatted area 112, and a html file to be displayed in left hand portion 114. The latter one of these files must of course be of variable length to allow it to be displayed in the configuration shown in both FIG. 2A and FIG. 3 while the second formatted area 118 will commonly be a simple photograph attached as a Jpeg file.

The client may also specify a number of web links, such as 3, to appear at the bottom of the users Main menu when the skin is loaded.

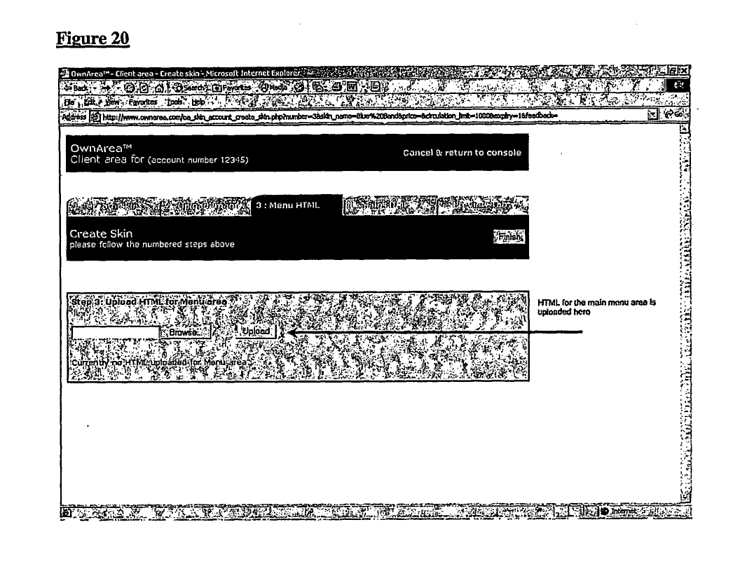

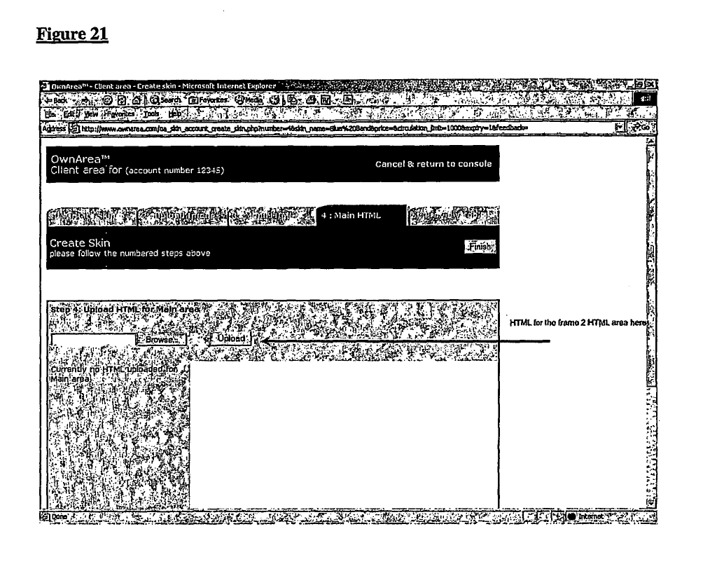

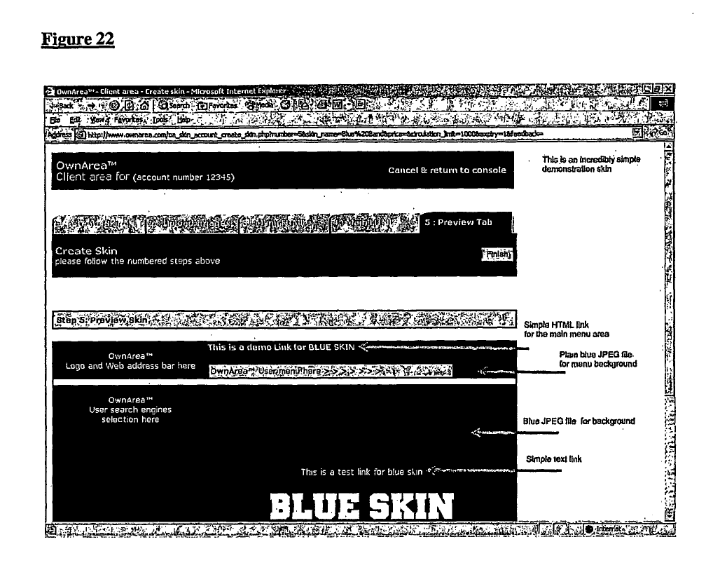

The Jpeg file corresponding to the second formatted 118 is selected and uploaded under this upload images tab 272 displayed in FIG. 19 whilst the html file for the first formatted area 112 is selected and uploaded by the third tab, the menu html tab 274 displayed in FIG. 20 and the html corresponding to left hand portion 114 is selected an upgraded by the fourth tab, the main html tab 276 as shown in FIG. 21. The user may then select the fifth tab, the preview tab 278 as shown in FIG. 22 which displays a preview of the uploaded images as they will be viewed by a user U.

Instead of uploading the images the skins may also be accessed by the skins databases 28 and 30 by the client uploading url addresses for where the HTML and graphic tables reside. This allows the client to update the content by changing the file on the client PC 16 or 18 and the skin consists of url addresses that retrieve the data from the client PC 16 or 18 via the user Us browser bandwidth.

Once finished the client C may send these complete three files to the web browser 12 which are then stored by the processor 26 in the live skins database 28. The operator of the web browser 12 can then view the skins stored in the pending skins database 28 and consequently approve or not approve the submitted skin. Once approved by the operator via operator web pages 50 the approved skin is entered into the live skins database 30. The client C may come back to these pages at 268 at anytime to make further changes to the skin format stored in the pending skins database 28 but each time they do so the skin must be approved by the operator before it enters the live skin database 30.

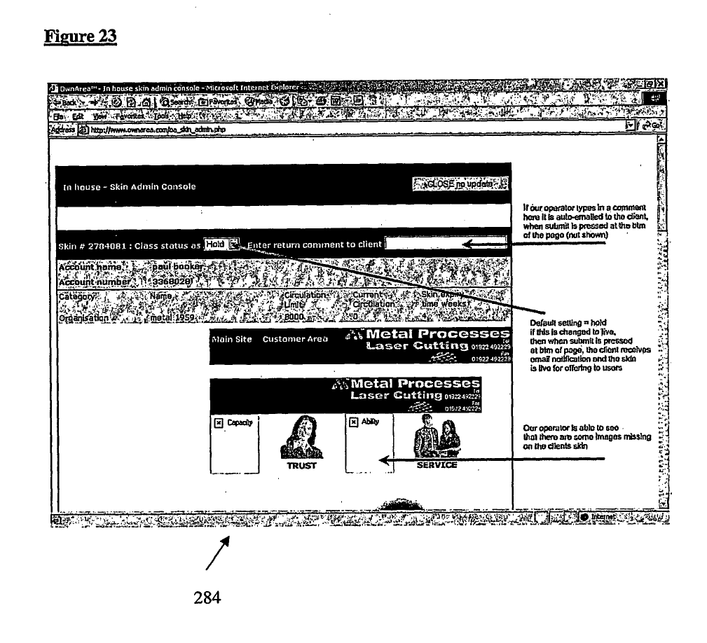

In FIG. 23 is shown page 284 which forms part of the operators pages 50 and is preferably only viewable by the operator PC 14 or possibly the operator using a required password from any PC. On Page 284 an operator of the web server 12 is able to view the submitted skin and either approve the skin in which case it will enter the live skins database 30 and then become selectable by user U or to disapprove and send relevant comments back to the client C via communication channel 52 such that they may alter their Skin in order to comply with the requirements of the operator.

In an alternative embodiment the client C may also specify a graphical image to include in the branded area 401 and also specify a html table to include in area 402. The Client C may also specify a number of text items and web links (say up to 3) to form a live “ticker” viewable to the user within the users browser function area 403. Again this client data can be being stored on an independent server thereby being updatable at any time.

In a an alternative embodiment the skins need not be approved by an operator viewing the operator web pages 50 and sent directly to the live skins database 30 by the client.

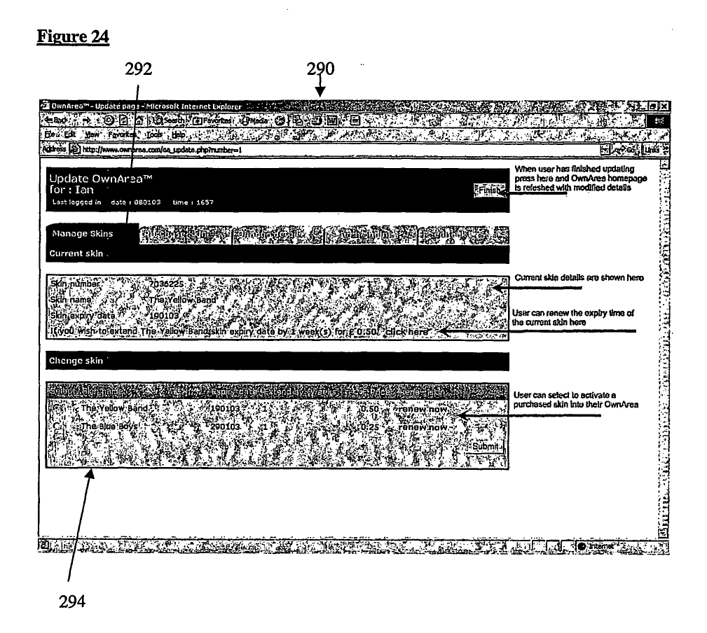

In FIG. 24 is shown the update page 290 forming part of client pages 38 which is presented to a user U when they wish to change, alter or select the skin. In FIG. 24 the first tab 292 is shown selected which allows the user to manage their skins. As can be seen the current selected Skin which will be displayed in the present formatted areas is displayed showing its Skin number 280, Skin name, expiry date and the cost of extending this expiry date. Also shown are any other Skins which the user has previously selected and the user U may change the selection to one of these stored skins 294.

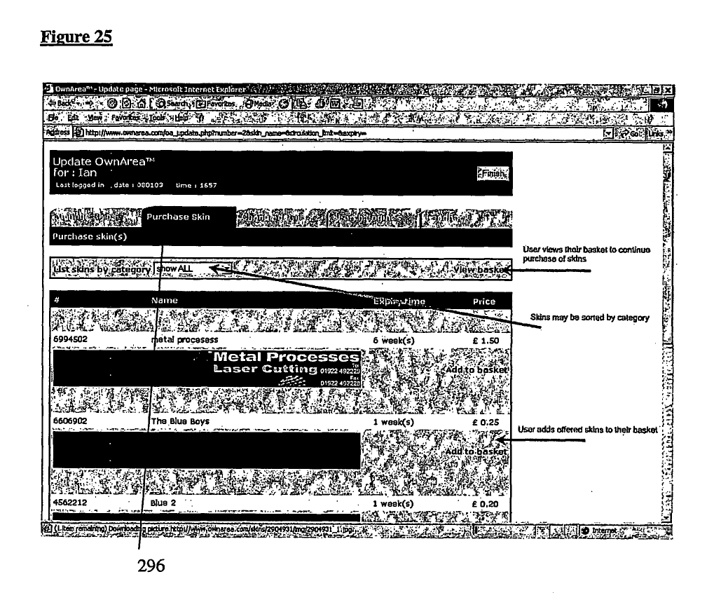

The second tab 296 can then selected as shown in FIG. 25. Tab 296 allows a user to purchase new skins. The user U can view skins stored in the live skins database by categories which have been entered for each skin. Once purchased the skin will be added to the list 294 displayed under the first tab 290. In the case of location, gender or age specified skins the user U can only view those skins which his or her registered details permit.

The user U may also receive skin offers, delivered to their homepage 100. The client C sender can be charged a fee for doing sending such offers and the system 10 is intended to be used for low volume, highly relevant offers based upon user suitability.

In this case, the user will see a graphical representation of the amount of skins currently sent to them, the user may choose to view, install or delete each skin.

Age specified skins can be used to allow children to only access skins that are considered suitable. The skins can be graded as only allowing users with a date of birth before a certain date to access the skin. In a preferred embodiment such age specified skins can be used to provide a safe environment for child users which they can access without being given access to other sites on the internet, In order to achieve this, such age specified skins are designed to cover areas 106, 114 and 116 as well as 112.

These “child accessible” skins are designed so that there is no URL address bar present on screen and no web sites are viewed in area 116. The drop down menu 110 remains but the child's account is configured so that preferably whilst the “skins” section of the menu 110 remains, allowing the child to access suitable skins, there is no “main” section and no stored links. Consequently the child user is not able to access other web sites via the skin.

Child accessible skins are also configured to hide the navigation controls of the user's browser and may for example take the form of a pop up window. How the child can access the web page 38 depends on how the adult responsible for that child wishes to have their computer/their user account set up but there could for example be a desk top shortcut provided which accesses the child's account and opens in the form of a pop up window

The child's account is preferably set up by a supervising adult and the user name, password and account information entered into the user identification database 32 by the adult. The child's account information in the database 32 can be linked to an account information of the adult allowing the alter the saved information profile of the child such as changing the date of birth when logged in under the adult's username and password.

If the adult wants to determine themselves whether each skin is suitable for the child user they may mark the child's profile as only being allowed to access skins approved by the adult. The adult can then select skins they judge to be suitable, with these selected skins being stored in the user information database 34. The child logged in under their username and password is then denied access to all skins except those that have been selected and stored by the adult.

In another embodiment the skins in the live skins database 30 are presented to the user U in the form of a list, each skin being represented by one or more words numbers or symbols. Each representation is accompanied by a preview link which allows the user U to see the background image of the skin.

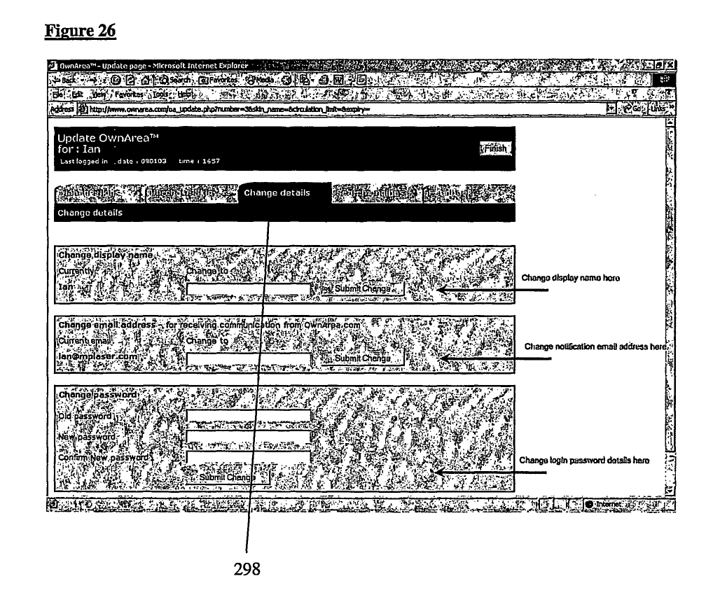

The third tab 298 allows user is to change their personal details and password information stored in the user information database 34 and this tab is shown selected in FIG. 26.

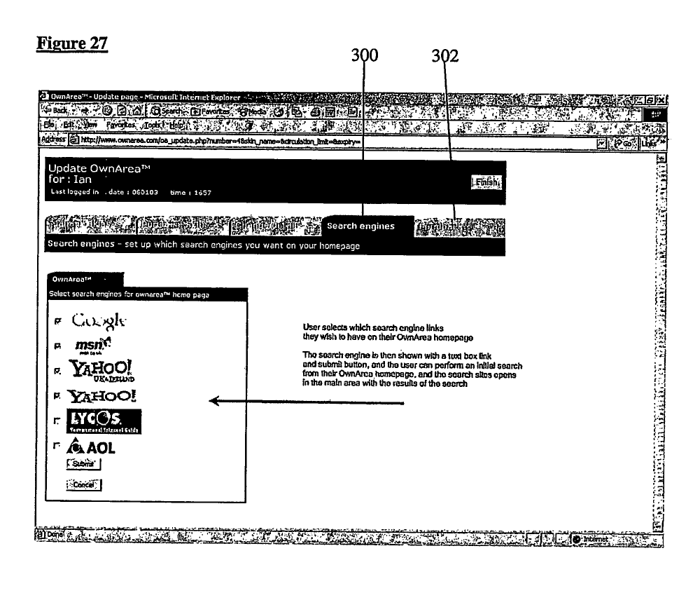

The fourth tab 300 is shown selected in FIG. 27, this fourth tab 300 allows a user to select which search engine they would like stored in the user information database 34 and accessible to them in web pages 38.

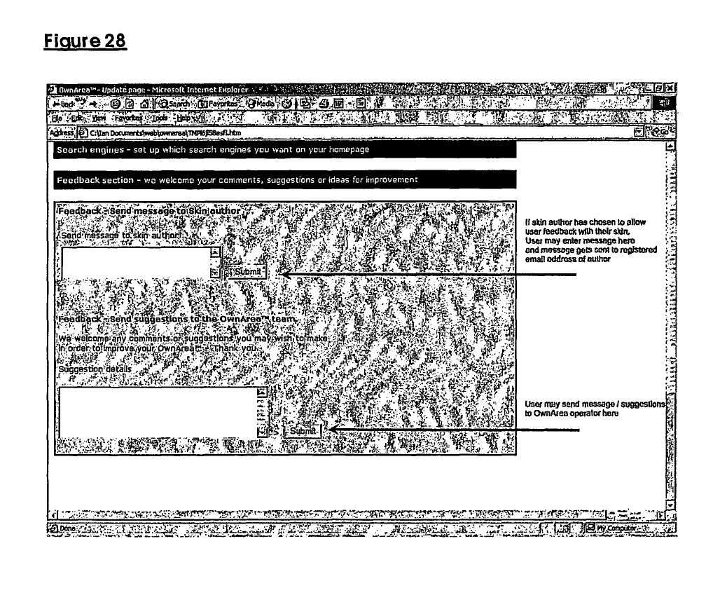

The fifth tab 302 is shown selected in FIG. 28, this fifth tab 302 allows a user to send feedback to the client C via communication channel 44. As can be seen from FIG. 28 this feedback can take the form of a message and suggestion details and can be sent both to the client and to the operator of the web server 12.

When the expiry period of a skin runs out it can now longer be displayed in user web pages 38 and is removed from the live skins database 30. Should a skin have a price above zero and this price not be paid by a user the skin will remain in the live skins database 30 but will be blocked from use by the non-paying user U.

The ability to check the user's unique user identification numbers of web browsers by clients C can be rationed by the operator of the system 10. In these circumstances, the operator can charge the clients C per unique user identification number obtained. It is also possible to allow the client C to access data on which and how many users have used or viewed their skins in the live skin database.

In an alternative embodiment the invention can be implemented as a downloadable or installed computer based software browser application or as a browser plug-in which plug in reconfigures the browser in the user PC 20 so that it the links stored for that user U in the user information database 34 are inserted into the favourites of the browser and the selected skin is displayed on screen.

The software browser application comprises an email software application and chat software application that are both linked to the main browser software. The email software and chat software computer applications also has have what may be termed “above the menu bar” content (equivalent to first fame 102) that is based on the user's current skin that is set within their online settings. The software browser requires a user log in process and obtains the relevant skin and favourite stored web links and profile information from the server 14. This means that a user U may still access their own personal settings and information from the user information database 34 within the software version if it is installed on the PC 20 they are using.

IN the computer installed browser software application embodiment the guardian can allow specified web site addresses to be allowed access to by a child account on a one by one opted in basis. This means that the child will have access to the address bar but will only be able to gain access to websites that have been pre-specified by the guardian. Any hyper links from any specified sites that link to non specified sites will either be rendered as inactive links” or be rendered active on the page but refuse access to the child user if they are clicked on.

Both the webpage 100 based embodiment and the installed software embodiment of the email client application can have two email inboxes, a “trusted” inbox and an “un-trusted” inbox. The user U can have email automatically come into their un-trusted inbox, and then have the facility to flag an email address within the un-trusted inbox to be set to a trusted status email address.

The user is able to set the email system to automatically delete the un-trusted email either every day, or every week. The user can then hide the un-trusted email box when ever they wish so that they will only see received messages from pre-specified trusted email addresses into their trusted email box and all SPAM and unwanted emails will be dealt with for them in their un-trusted email inbox.

Is a user receives a legitimate email into their un-trusted box, because it has not yet been specified as trusted within their set auto un-trusted email delete period since the email in question was sent then the user can simply show the un-trusted inbox again, find the email in question set it's address to trusted status and switch the un-trusted inbox box off again.

When the user is using the computer software installed version the unique identification number may be passed to the website loading into area 104 via a specifically named cookie, that the browser will permit to be passed to the external web server, or additionally the number may be passed to the external website via the general browser details information that may be queried by the site.

There may also be provided a web page that lists all the directory structure and web links contained within the users menu, via this page each url link name will open the link website in an external new browser window.

What is claimed:

1. A web server comprising a memory and an information processor, the memory including a stored web page viewable by a remote user, wherein the stored web page is alterable by the remote user in at least one of appearance and function.

2. A web server according to claim 1 in which the memory contains one or more addresses such as urls (uniform resource locators) addresses, useable by a remote user to locate and view web sites not stored in the memory.

3. A web server according to claim 2 wherein the address urls can be deleted by a remote user and/or additional address urls created by a remote user can be stored in the memory and/or the address urls can be edited by a remote user.

4. A web server according to claim 2 wherein the stored web page comprises one or more links to other web pages corresponding to the stored address urls.

5. A web server according to claims 3 wherein when an address url is edited, created or deleted a corresponding alteration is made to the link on the stored web page.

6. A web server according to claim 4 wherein if a link is activated by a remote user the web site accessed which is not stored in the memory is opened as a frame within a stored web page.

7. A web server according to claim 4 wherein the address urls are categorized in the memory and the links to other web pages displayed on a stored web page and viewable by a remote user correspond to the address urls of a category selected by the remote user.

8. A web server according to claim 4 wherein the position of the link(s) on the webpage can be altered by the remote user and the altered position of the link is stored in the memory of the web server.

9. A web server according to claim 2 in which address urls can be downloaded into the memory of the web server from address urls stored in the memory of a computer of a remote user.

10. A web server according to any claim 1 wherein the stored web page comprises one or more graphic icons, the position of the icon on the webpage can be altered by the remote user and the altered position of the icon is stored in the memory of the web server.

11. A web server according to claim 1 wherein the stored web page comprises an embedded language which accesses other information stored in the memory and the web page is viewable by a remote user in a first configuration displaying a first set of accessed information and a second configuration displaying a second set of accessed information the configuration viewed by the remote user depending on an action taken by the remote user, wherein either the first set or second set of information and preferably both can be altered by the remote user the altered information stored in the memory.

12. A web server according to claim 11 when dependent on claim 2 in which the second set of information comprises links to other web sites corresponding to the stored address urls.

13. A web server according to claim 7 in which the second set of information comprises links to other web sites corresponding to the address urls of a category selected by the remote user.

14. A web server according to claim 13 in which the first set of information contains areas for categories of address url and there is a configuration for each area displaying a set of information comprising links to other web sites corresponding to the address urls of the category of that area.

15. A web server according to claim 14 in which the web site changes from being viewed in the first configuration to a configuration of a category by a remote user selecting, such as by pointing a cursor, the relevant area.

16. A web server according to claim 1 wherein the stored web page comprises a formatted area consisting of a set of data viewable by a remote user wherein the data can be selected by the remote user from a series of sets of data stored in the memory.

17. A web server according to claim 16 wherein a set of data stored can be created and submitted to the memory from a remote computer.

18. A web server according to claim 17 in which the submitted set of data can be reviewed by a second remote computer before that set of data becomes selectable by a remote user.

19. A web server according to claim 16 in which a stored set of data has an expiry date, so that when the expiry date is passed the set of data can no longer be selected by remote users.

20. A web server according to claim 16 to which can request payment from a remote user when a set of data is selected and/or can request payment from another party such as the data submitter before that set of data becomes selectable by a remote user.

21. A web server according to claim 20 comprising identification means for identifying remote users, the web server memory containing information about remote users such as date of birth and gender, and the other party is can specify which users will be able to select the submitted data set and preferably wherein the server can request a payment which is dependent on which users or amount of users are specified.

22. A web server according to claim 16 when dependent on claim 6 in which the formatted area occupies the frame in which selected web sites can be displayed.

23. A web server according to claim 16 when dependent on claim 6 in which the formatted area is separate from the frame in which selected web sites can be displayed such that the selected set of data is displayed alongside the selected web page.

24. A web server according to claim 16 wherein the set of data comprise a graphical image and/or html.

25. A web server according to any claim 1 comprising identification means for identifying remote users and wherein a stored web page is viewable to an identified user and alterations to that stored web page, including any alterations to urls corresponding to links on the web page or to change in selection of the set of data to be displayed in the formatted area, or to the position of a link or icon, are stored in the memory tagged to that identified user and a second differently identified user can not view information and web pages tagged to the first identified user.

26. A web server according to claim 25 wherein the identification means identifies remote users by requesting information such as a password and checking this information against information stored in the memory and displaying web pages to the user once identified that are tagged to the requested information such as a password.

27. A web server according to claim 25 in which the identification means allocates an identification number to each identifiable remote user and allows this number to be accessed by, or gives this number to, external web servers of web pages accessed through the stored web page thereby allowing external web servers to also identify remote users.

28. A web server according to claim when dependent on claim 16 wherein a first identified user is able to choose which of the sets of data from the series of sets of data stored in the memory, a predetermined differently identified user is able to select, the predetermined differently identified user being unable to select or view sets of data which have not been chosen by the first identified user

29. A web server according to claim 27 when dependent on claim 27 wherein the information stored in the memory against which the requested information entered by the predetermined differently identified user is checked in order for the predetermined user to be identified, is entered in to the memory by the first identified remote user.

30. A web server according to claim 16 when dependent on claim 14 comprising identification means for identifying remote users, the web server memory containing the date of birth of a remote user and wherein stored sets of data has a defined acceptable age range, so that remote users with an age, calculated from the date of birth, outside the acceptable age range can not select those stored sets of data.

31. A web server according to claim 29 wherein the stored web page viewable by a remote user has no means for accessing web pages not stored in the memory of the web server.

32. A web server according to claim wherein the stored web page viewable by a remote user prevents the remote user from using the browser with which the web page is opened to access web pages not stored in the memory of the web server such as by opening as a pop-up window.

33. A web server comprising a memory and information processor, the memory includes the stored web page viewable by a remote user, the web server further comprising identification means for identifying remote users wherein a stored web page is viewable to an identified user, identified users can access web pages hosted by external web servers via the stored web page, and the web server allocated an identification number to each identified user, wherein the web server is able to communicate with external web servers and transmit to them the identification number of any user accessing a hosted web page stored on that external web server via the stored web page.

34. A method of facilitating electronic marketing to individuals comprising the steps of:
setting up an electronic address for each individual accessible via a web server,
requiring the individual to enter security information such as a username and password in order to access their electronic address and allowing the electronic address to be accessible to its corresponding individual over the internet from multiple different computers,
requesting and storing information about individuals,
enabling third parties to select individuals based on the stored information,
enabling third parties to send marketing material such as advertising to the electronic addresses of the selected individuals,
requesting feedback from selected individuals and relaying feedback to third parties enabling them to make a decision as to whether to continue sending marketing material to that individual.

35. A method according to claim 34 wherein the electronic address is a web page or a browser and the marketing material is displayed on the webpage or within the browser window preferably for over an hour or a day.

36. A method according to claim 34 in which the information requested includes which companies the individual would permit or like to receive material from and/or the individual may select which material that he or she has been sent is displayed.
